(19) United States
(12) Patent Application Publication
(10) Pub. No.: US 2024/0238708 A1
(43) Pub. Date: Jul. 18, 2024

(54) Sealing Assembly and Method of Use Thereof

(71) Applicants: William N. TALLY, Farmington Hills, MI (US); Renew Health Ltd, Athlone (IE)

(72) Inventors: William Tally, Milford, MI (US); Thomas Reesbeck, Farmington Hills, MI (US); Jeffrey Dupuis, Royal Oak, MI (US)

(73) Assignee: Renew Health Ltd, Athlone (IE)

(21) Appl. No.: 18/289,491

(22) PCT Filed: May 2, 2022
(86) PCT No.: PCT/US2022/027302

§ 371 Date: Nov. 3, 2023

Related U.S. Application Data
(60) Provisional application No. 63/184,275, filed on May 5, 2021.

(51) Int. Cl. B01D 35/30

(52) U.S. Cl. CPC B01D 35/306; B01D 2201/34

(57) ABSTRACT

The disclosure relates to devices and methods for reducing fluid leakage. The devices and methods are applicable to all fluid-containing systems and are particularly relevant to water treatment systems.

### BACKGROUND

In many situations, the flow of fluids results in pressure on device components which may lead to fluid leaks, particularly at connections between components. For example, water treatment systems may involve one or more filtration units and water may leak at points where water flows into or from a filtration unit. The leakage of fluid reduces the overall efficiency of the system due to, for example, both fluid loss and a requirement for maintenance. The disclosure relates to devices and methods to reduce fluid leakage, resulting in less waste and a more efficient fluid-containing systems.

### SUMMARY

The disclosure relates to devices and methods to reduce fluid leakage. The devices and methods may be used, for example, in water treatment systems. In general, sealing assemblies are disclosed, where a sealing assembly includes at least one sealing device, and at least one endcap. Sealing assemblies may also include at least one filter center connector.

The sealing device may assume different shapes but generally includes a wall with a central lumen which acts as a conduit for the flow of fluid. The exterior surface of a sealing device has at least two ridges, where the placement of the ridges forms grooves in the sealing device. O-rings are fitted into the grooves. In general, the sealing devices fit into an orifice of an endcap where the O-rings engage the interior surface of the endcap orifice, creating a watertight seal between the exterior surface of the sealing device and the interior surface of the orifice of the endcap. The sealing devices may be used in a variety of systems where the flow of fluid occurs, reducing leakage.

### BRIEF DESCRIPTION OF FIGURES

FIG. 1 shows a perspective view of a sealing device according to the disclosure.

FIG. 2 shows a view of a sealing device as seen from the side.

FIG. 3 shows a cross-sectional view of a sealing device according to the disclosure.

FIG. 4a shows a perspective view of another example of a sealing device according to the disclosure.

FIG. 4b shows a view of a sealing device as seen from above showing a central orifice.

FIG. 5 shows a disassembled view of a sealing assembly.

FIG. 6 shows a disassembled view of a sealing assembly with sealing device removed.

FIG. 7 shows a cross-sectional view of a water filtration cartridge with the locations of sealing assemblies circled.

FIG. 8 shows an expanded cross-sectional view of a sealing assembly located in a water filtration cartridge.

FIG. 9 shows an expanded cross-sectional view of another sealing assembly located in a water filtration cartridge.

FIG. 10a shows a perspective of an endcap according to the disclosure.

FIG. 10b shows a second perspective view of the endcap.

FIG. 11 shows a top view of the endcap from FIG. 10.

FIG. 12 shows a cross-sectional view of an endcap from FIG. 11.

FIG. 13 shows a top view of a further example of an endcap according to the disclosure.

FIG. 14 shows a bottom view of the endcap of FIG. 13.

FIG. 15 shows a further top view of the endcap of FIG. 13.

FIG. 16 shows a further bottom view of the endcap of FIG. 13.

FIG. 17 FIG. 16 shows a cross-sectional view of the endcap of FIG. 13.

### DESCRIPTION

The systems, devices and methods described herein are not limited in their application to the details of construction and the arrangement of components set forth in the description or illustrated in the drawings. Also, the phraseology and terminology used herein is for the purpose of description and should not be regarded as limiting. The use of “including”, “comprising”, “having”, “containing”, “involving” and variations thereof herein, is meant to encompass the items listed thereafter, equivalents thereof, and additional items, as well as alternate embodiments consisting of the items listed thereafter exclusively.

This disclosure relates to systems, devices, and methods to reduce leakage in fluid-containing systems. In preferred examples, the disclosure relates to devices and methods for reducing leakage of water. For example, the devices and methods of the disclosure may be used in water treatment or water purification systems. The devices and methods disclosed herein will reduce fluid leakage, thereby increasing the life of the device, reducing maintenance costs, or increasing the efficiency of water treatment or a combination of these effects. According to the disclosure, existing systems may be easily adapted to incorporate the devices and methods.

In preferred examples, a sealing assembly includes at least one sealing device and at least one endcap. The assembly may also include at least one filter center connector. In a sealing assembly, at least one sealing device engages with and forms a watertight seal with at least one endcap. The sealing assembly may be assembled or integrated with other components such that the sealing assembly is fluidly connected with the other components. For example, the assembly may be placed at the point where one water filtration unit is fluidly connected to a second water filtration unit, such that water flows from one filtration unit through the sealing assembly to a second filtration unit. The sealing assembly may be adapted to a particular situation by adapting the structure of the sealing device or endcap or both sealing device and endcap.

In general, devices of the disclosure may be composed of materials compatible with prolonged exposure to fluids. In preferred examples, devices are composed of materials compatible with specific requirements for water, such as for drinking water. In preferred examples, the materials are food grade quality. The devices of the disclosure are composed of materials that withstand mechanical stress. For example, devices may be composed of plastics. For example, acrylonitrile butadiene styrene, Delrin or nylon alone or in combination may be used. In general, a sealing device is manufactured as a single piece. Sealing rings such as O-rings may be mounted, inserted, or placed on the sealing device where the O-rings are formed from food-grade materials.

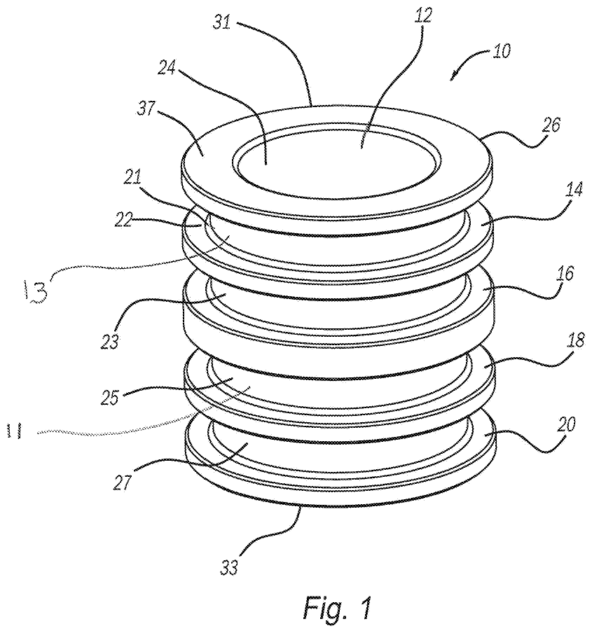

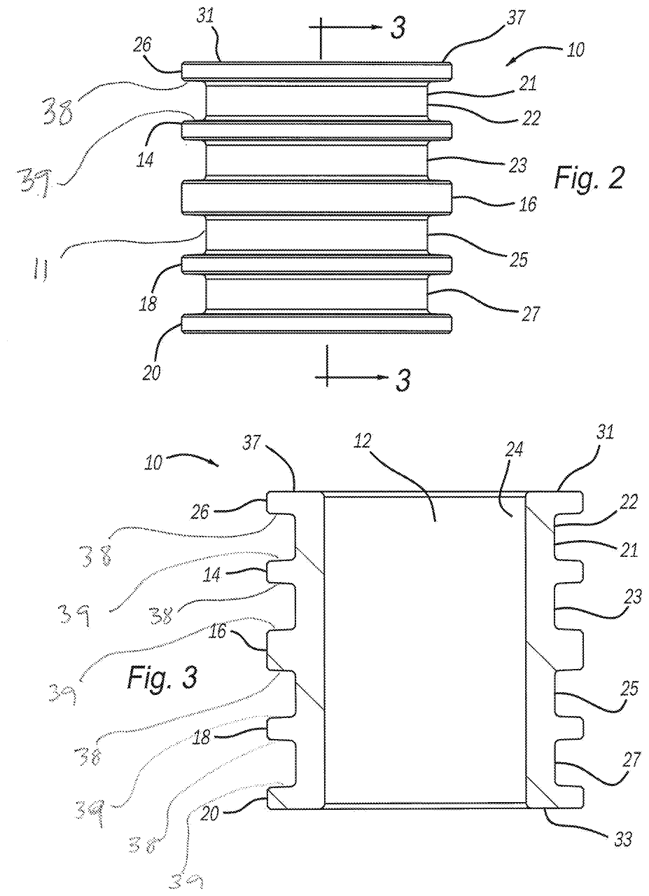

FIGS. 1-3 show three views of an example of a sealing device according to the disclosure. In these figures, the sealing device is shown as generally cylinder-shaped. That is, the wall is formed into cylinder and a lumen extending through the sealing device is cylindrical. In other examples, the sealing device may assume other shapes as required, such as barrel-shaped, cuboid, or a combination of shapes. For example, the sealing device exterior could be barrel-shaped, but the lumen may be cylindrical. Barrel-shaped includes those shapes where the width or cross-sectional area of the device is greater at the midpoint of the device's height than at either end of the device. The height, diameter, depth or width of the sealing device, as well as the dimensions of ridges, grooves, orifices, lumens or walls may vary with requirements for a particular use.

For reference, a first axis of a sealing device is defined by the direction of the flow of fluid through lumen of the sealing device. The height of the sealing device is the dimension along the first axis from a first edge of the device to a second edge. A cross-sectional area of the lumen lies along a horizontal plane that is perpendicular to the first axis. In the example of a cylindrical lumen, the diameter of the lumen cross-section extends in a straight line from the second (inner) surface at one point through a circle midpoint to an opposing point of the second surface. The diameter may be used to determine the area of the lumen cross-section.

The inner surface area of the sealing device is defined by the area of the second surface. An outer surface area is defined by the first surface. The total surface area of the device is the sum of the inner and outer surface areas and the area of the first and second edges. An outer perimeter of the sealing device is the dimension of the device defined as the perimeter of a cross-section that extends to and includes the first surface. An inner perimeter of the sealing device is the dimension of the device is defined as the perimeter of a cross-section that extends to and includes the second surface. For a cylindrical sealing device, the outer perimeter is an outer circumference of a cross-section including the first surface. For a cylindrical sealing device, the inner perimeter is an inner circumference of a cross-section including the second surface.

In the example shown in FIGS. 1-3, the sealing device 10 includes body 11 having wall 13. In this example, wall 13 forms a cylinder, having a central lumen 12. Wall 13 has a first surface 22, defining the exterior-facing portion of the wall and a second surface 24 defining the interior-facing portion of the wall. Body 11 also includes first edge surface 31 and second edge surface 33. In this example, first edge surface 31 and second edge surface 33 are flat. In other examples, first and second edge surfaces could assume different shapes as required, such as rounded. The height of the sealing surface extends along the first axis from the first edge to the second edge.

The sealing device 10 includes a central orifice or lumen 12. In this example, second surface 24 of wall 13 defines the shape of lumen 12. In this example, the lumen is cylindrical. The lumen extends through the entire height of the sealing device. The lumen acts as a conduit for fluid when the sealing device and assembly are placed in a system, such as a water treatment system. The lumen shape or dimensions, such as diameter, perimeter, radius, or cross-sectional area, may be determined by the requirements for fluid flow, such as gallons per minute outputted in a water treatment system.

In the example shown in FIGS. 1-3, ridges extend horizontally from the first surface of the wall. That is, the ridges extend from the first surface 22 of the wall 13 at approximately along a horizontal plane perpendicular to the first axis. Each ridge extends around the entirety of outer perimeter or circumference of the sealing device. The ridges are approximately parallel in this example. In this example, the sealing device has a central ridge 16 extending horizontally from the first surface and centered at the approximate midpoint of the height of the sealing device.

In this example, secondary ridges 14, 18, 20, 26 are found above (14, 18) and below (20, 26) the central ridge 16. That is, the ridges are positioned symmetrically along the height of the sealing device. In this example, secondary ridges 10, 26 extend from the top and bottom edges 31, 33. In this example, the height (dimension along first axis) of the central ridge 16 is greater than the height of the secondary ridges. In this example, the heights of the secondary ridges and of the central ridge is approximately uniform along the entire horizontal extension of each ridge. The placement of ridges along the height of the of the sealing device results in the formation of grooves 21, 23, 25, 27, located between ridges. That is, grooves are spaces formed between or are defined by surfaces 38, 39 of adjacent ridges and the second surface 22. Grooves extend around the entire perimeter of the wall of the sealing device.

Table 1 presents one example of the dimensions of a sealing device according to the disclosure.

TABLE 1

| Sealing device | Approximate |
|---|---|
| feature | Dimension (mm) |
| Height | 32 |
| Lumen diameter | 19 |
| Device diameter including first surface | 24.5 |
| Height of secondary ridges | 1.8 |
| Height of groove (distance | 4.4 |
| between adjacent ridges) | |
| Height of central ridge | 9.4 |
| Wall thickness (first surface | 5.5 |
| to second surface distance) | |
| Horizontal extension of ridges | 5.4 |
| from first surface | |

In preferred examples, sealing rings, such as O-rings, may be fitted into the grooves 21, 23, 25, 27 created by the placement of the ridges above and below the central ridge 16. When inserted into a groove, an O-ring fits around the entire perimeter of the wall of the sealing device. When inserted into a groove a portion or surface of each O-ring contacts the first surface 22 of the wall 13 and adjacent surfaces of ridges 38, 39. A portion of O-ring extends horizontally farther than the maximum horizontal extension of each ridge, such that a portion of the O-ring is available to contact the surface of another, second component, and the O-ring deforms, thereby creating a watertight seal between the sealing device and the second component. The properties of the O-ring, such as material and dimensions are selected such that contact stress between the O-ring and surfaces are greater than the fluid pressure generated by the system.

In the example of FIG. 1-3, secondary ridges are spaced the same distance apart along the first axis and the secondary ridges have a uniform height thereby creating grooves of the same height. In other examples, ridges may be placed at different distances apart or may have different ridge heights, thereby creating grooves of different dimensions, allowing the placement of differently-sized O-rings on the sealing device.

The size, number, dimensions and distribution of ridges and grooves may be altered according to requirements for a particular system. For example, some sealing devices may have two secondary ridges, one secondary ridge below the central ridge and one secondary ridge above the central ridge, creating two grooves in the sealing device. Some examples may have more than two secondary ridges above the central ridge or more than two secondary ridges below the central ridge, thereby having more than four O-rings inserted on the sealing device. The number of ridges and grooves may be asymmetric, such that there may be more grooves above the central ridge than below the central ridge.

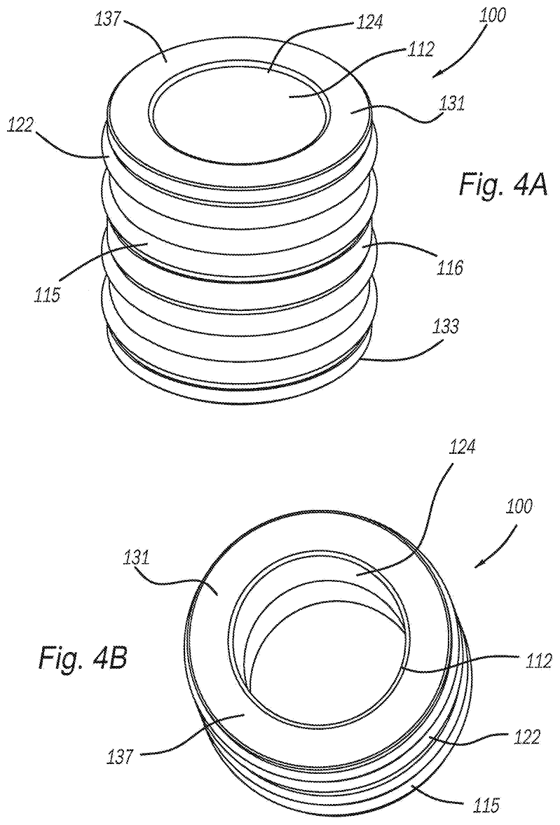

In FIGS. 4a and b, another example of a sealing device is shown. where the device is similar to other examples, but the O-rings 115 have been over-molded onto the sealing device. In this example, sealing device 110 includes wall 121, sealing device first surface 122 where the first surface defines the exterior of the device, second surface 124 that defines the interior of the device. In this example, first edge surface 131, and second edge surface 133 of the device. The sealing device 110 includes a orifice or lumen 112. The lumen acts 112 as a conduit for fluid when the sealing device is placed in a system, such as a water treatment system.

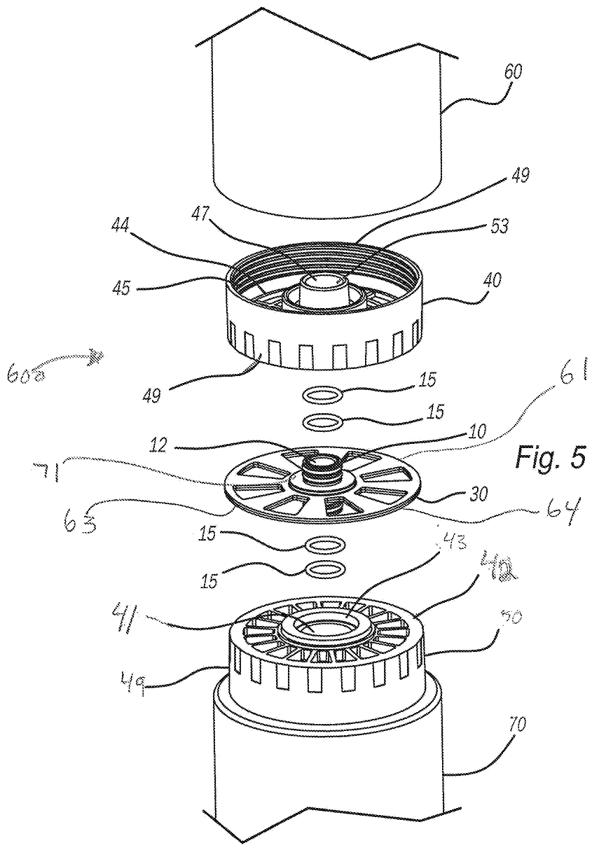

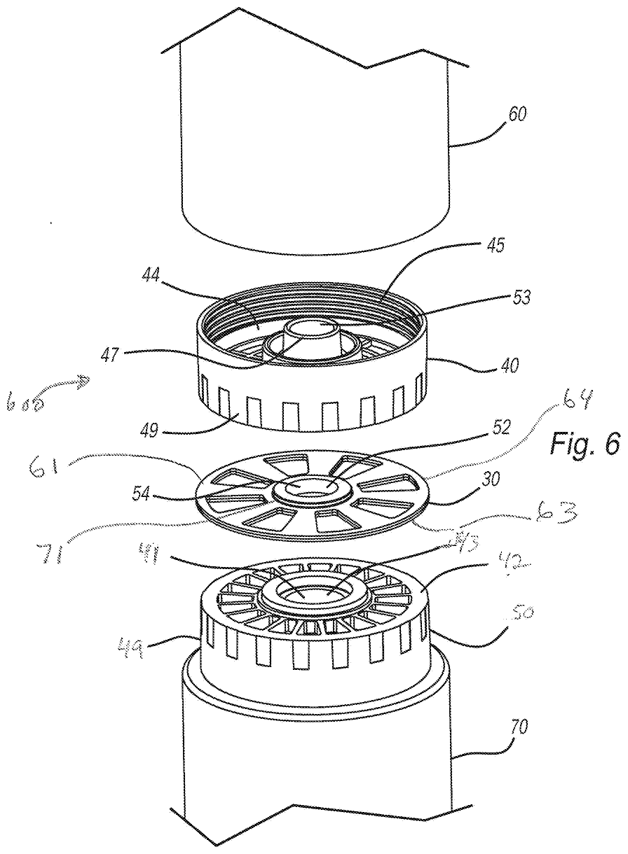

Referring to FIG. 5 and FIG. 6, one example of a sealing assembly according to the disclosure is shown in an exploded view when placed between and fluidly connected with two filtration units 60, 70. FIG. 6 shows the same view as in FIG. 5 but with sealing device 10 and O-rings 15 removed. In this example, the sealing assembly includes a sealing device 10, first connector endcap 40, a second connector endcap 50, and filter center connector 30.

Filter center connector 30 is generally cylindrical in this example and has first surface 61, second surface 63 and height 64. The filter center connector has central ring 71 which includes central orifice 54 and inner orifice surface 52. In this example, ring 71 is cylindrical and central orifice 54 is cylindrical as defined by inner orifice surface 52. In this example, sealing device 10 is mounted into filter center connector 30 in orifice 54. In some examples, the sealing device 10 is retained in the filter center connector 30 by an interference fit. In this example, central ridge 16 of sealing device 10 engages inner orifice surface 52 of filter center connector 30 to establish an interference fit. In preferred examples, the height of the central ridge 16 is approximately the same as the height of ring 71 of the filter center connector.

FIGS. 5 and 6 also show a first connector endcap 40 and second connector endcap 50. In this example, the first and second endcaps are identical in structure and are generally cylindrical, thereby matching the general shape of filter center connector. Further, the diameters of endcaps 40, 50 are approximately the same as the diameter of the filter center connector. Connector endcap 40 is fitted onto filtration unit 60 and second connector endcap 50 fitted on filtration unit 70, both using threaded portions 45.

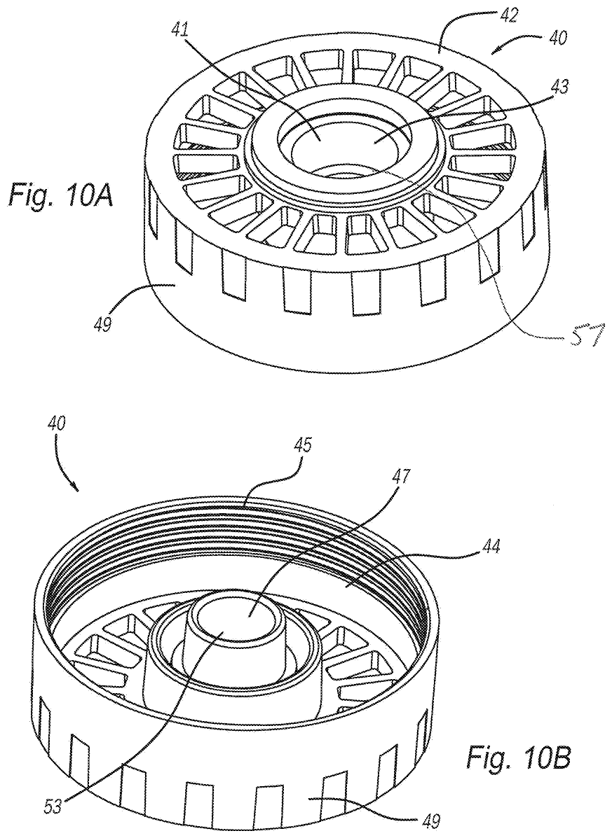

FIGS. 10-12 show isolated views of an example of a connector endcap shown in FIG. 5 and FIG. 6. FIG. 10A is a view showing a first upper surface 42 which includes a first upper orifice 41 having first upper orifice surface 43. Also present in this view is side exterior surface 49. In this example, first upper orifice is approximately cylindrical as defined by first upper surface 43.

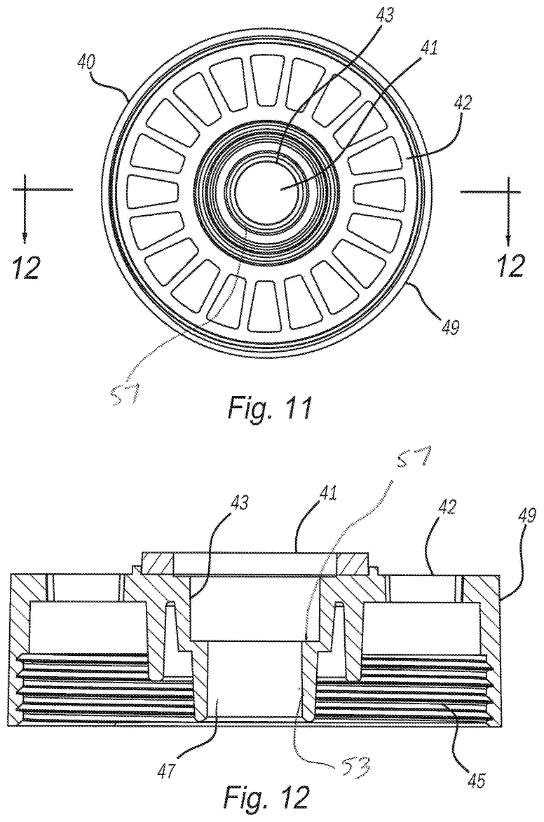

FIG. 10B shows the reverse view of the endcap showing interior surface 44, threaded portion 45, second lower orifice 47 with second lower orifice interior surface 53. The first orifice and second orifices are defined by interior orifice surfaces 43 and 53 and are approximately cylindrical. FIG. 11 shows the endcap as seen from directly above. FIG. 12 shows the endcap in cross-section, additionally showing the position of ridge 57, located in first upper orifice 41.

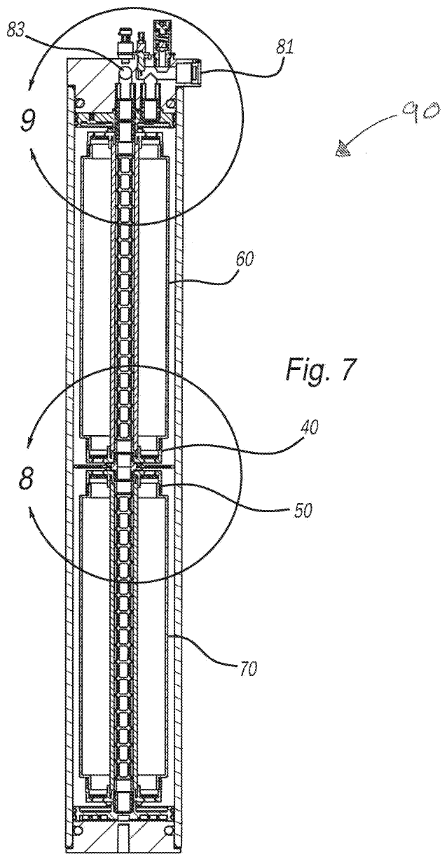

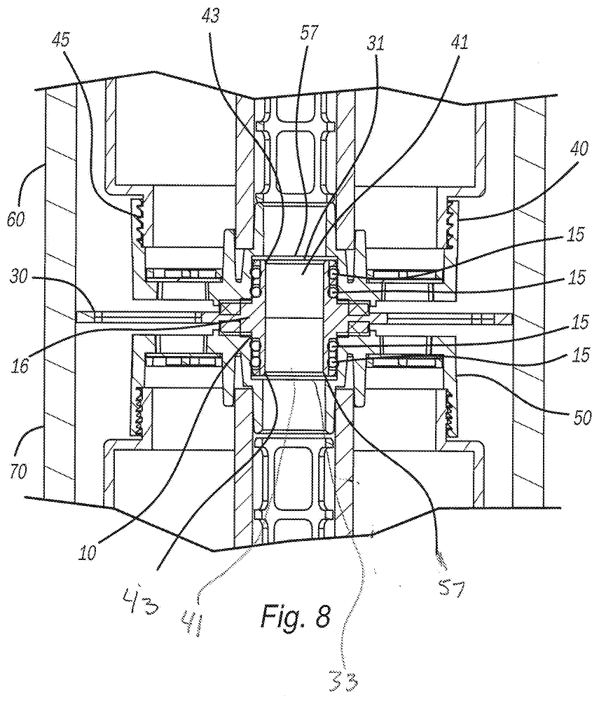

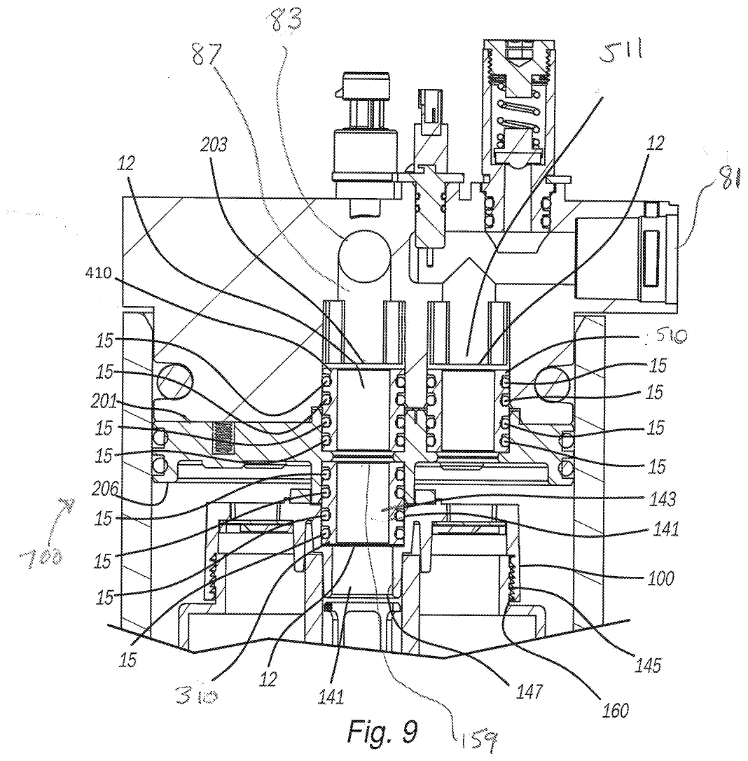

FIG. 7 shows an example of a water filtration cartridge that employs sealing device assemblies of the disclosure. The water filtration cartridge 90 includes water filtration units 60 and 70. FIG. 8 shows an expanded view of the region in the second circle of FIG. 7. FIG. 9 shows an expanded view of the region in the first circle of FIG. 9. In FIG. 7, water inlet 83 and water outlet 81 are shown.

FIG. 8 shows an expanded, cross-sectional view of the placement of a sealing assembly 600 from FIG. 7 in a water treatment system. In this example, the sealing assembly includes one sealing device 10, connector endcaps 40, 50, and filter center connector 30. In this example, endcaps, 40, 50 are positioned such that their respective exterior surfaces 42 are facing each other when assembled in the filtration cartridge.

Sealing device 10 is mounted in and retained by filter center connector 30 by an interference fit between central ridge 16 of sealing device and interior orifice surface 52 of filter center connector. In the assembled filtration cartridge, filter center connector surface 61 contacts exterior surface 42 of endcap 40 and filter center connector surface 63 contacts exterior surface 42 of endcap 50. The pressure of the contact with endcaps helps retain the position of filter center connector in the filtration cartridge.

According to this example, a single sealing device 10 extends through each of first upper orifices 41 of each endcap 40, 50 respectively. O-rings 15 located on sealing device 10 contact orifices surfaces 43 of first endcap 40 and of second endcap 50 to form water-tight seals between the orifice surfaces 43 of the endcaps and the sealing device 10. That is, two O-rings placed above the central ridge of the sealing device contact surface 43 of first endcap 40 and two O-rings below the central ridge contact surface 43 of second endcap 50. In this example, edge surfaces 31 and 33 of sealing device 10 respectively contact ridges 57 of endcaps 40, 50. The sealing assembly fluidly connects filtration units 60 and 70 where fluid flows through lumen 12 of sealing device 10 from one filtration unit to a second filtration unit. Further, first edge surface 31 of sealing device 10 contacts ridge 57 of endcap 40 and second edge surface 33 contacts ridge 57 of endcap 50, thereby further stabilizing the sealing assembly in the filtration cartridge.

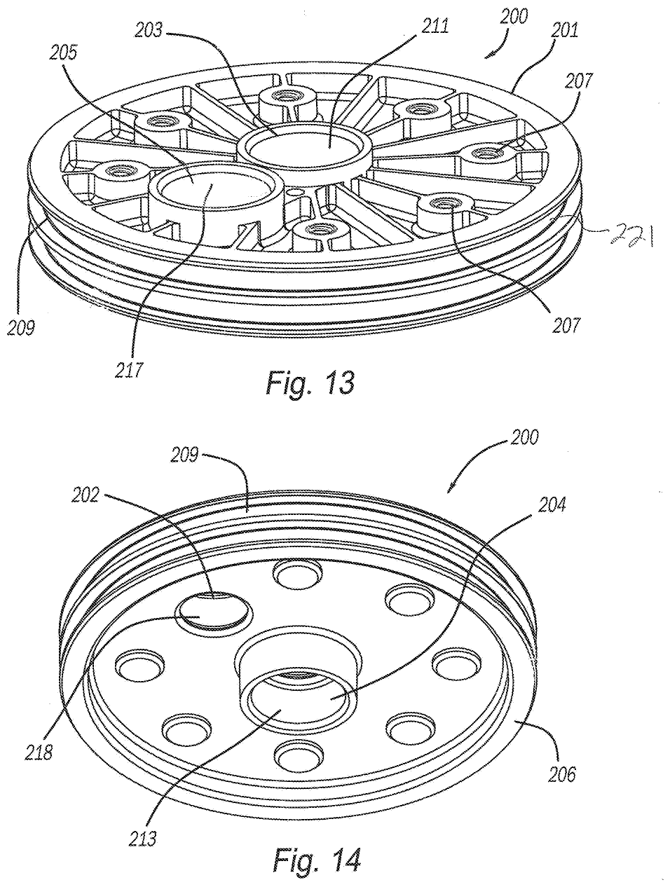

FIG. 9 shows another example of a sealing assembly 700 of the disclosure. This describes a sealing assembly used at the point where water exits a water treatment cartridge and where water enters the cartridge (the region in top circle of FIG. 7). The sealing assembly includes three sealing devices 310, 410, 510, first connector endcap 100 and dual endcap 200. FIGS. 13-17 show different views of a dual endcap according to the disclosure.

In the left side of FIG. 9, two sealing devices 310, 410, are fluidly connected in series where water flows through the lumens of the sealing devices, then through outlet 83. In the right side of the figure, water flows into the filtration cartridge through inlet 81 then through sealing device 510. As seen in previous examples, sealing devices 310, 410, 510 are similar and include O-rings 15 and lumens 12. Each of sealing devices 310, 410, and 510 have four O-rings but not all have been identified in FIG. 9 for the sake of clarity.

In the example of FIG. 9, connector endcap 100 is similar to the endcaps disclosed in FIGS. 5 and 6. Sealing device 310 engages with endcap 100 in a similar manner to previously described examples. Endcap 100 is threaded onto filtration unit 160 using threaded portion 145. In this example, two O-rings of sealing device 310 placed below the central ridge contact the interior orifice surface of 143 of the orifice 141 of the endcap 100. A surface of ridge 159 of endcap 100 contacts edge surface 133 of sealing device 310. Endcap 100 includes exterior surface 149.

FIG. 9, 13-17 also shows views of dual endcap 200. As shown in FIG. 9, this endcap is placed between filtration unit 160 and cartridge endcap 300 in an assembled water treatment system. Cartridge endcap includes inlet 81 and outlet 83 where fluid flows into and from the filtration cartridge respectively.

As seen in FIGS. 9 and 13-17, dual endcap 200 is generally cylindrical, where the cross-sectional shape is circular, matching the cross-sectional shape of the filtration cartridge. The dual endcap may have a cross-sectional diameter slightly less than the cartridge. Dual endcap contacts the cartridge endcap 300 on a first (upper) surface 201 of dual endcap 200. The dual endcap 200 may be fixed to cartridge endcap 300 using screws or other fasteners inserted into fastener orifices 207. In this example, dual endcap 200 includes height surface 209. Grooves 221 may be present in height surface where O-rings may be inserted in the grooves. The O-rings in grooves 221 may create a watertight seal between a surface of the cartridge and the dual endcap.

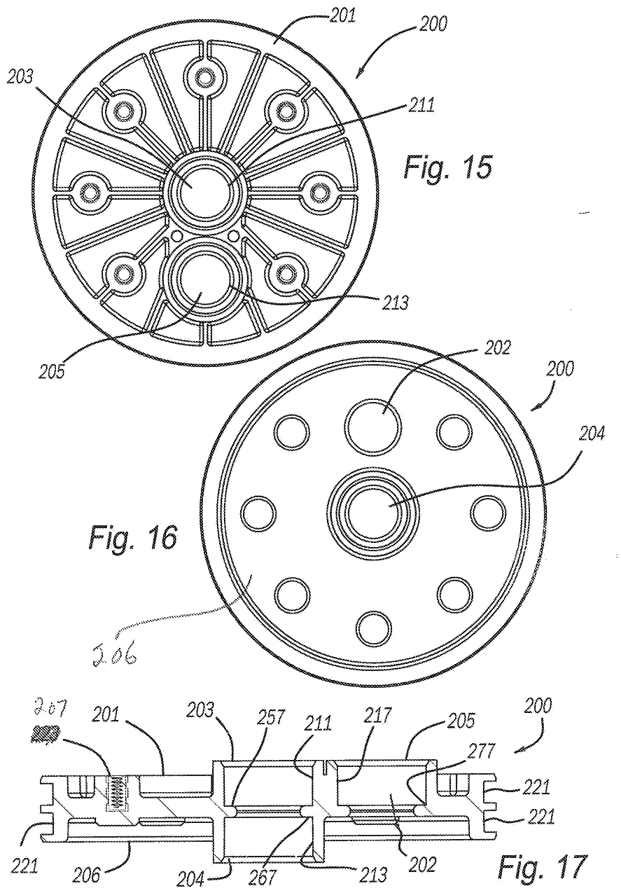

FIGS. 13-17 show further views of dual endcap 200. As seen in FIGS. 13 and 15, dual endcap 200 has first upper surface 201 and first and second upper orifices 203, 205, each having interior orifice surfaces 211, 217 respectively. Ridges 257, 277 are present in dual endcap orifices 203 and 205 respectively. FIGS. 14 and 16 shows a reverse view of dual endcap showing second surface 206, first and second lower orifices 202, 204, having interior orifice surfaces 213, 218. FIG. 17 shows a cross-sectional view of endcap 200.

As shown in FIG. 9, dual endcap 200 engages with sealing devices 310, 410, and 510. In this example, sealing device 310 also extends from filtration unit 160 to dual endcap 200 through first lower orifice 204. Two O-rings 15 above the central ridge of sealing device 310 contact first lower orifice surface 213 of dual endcap 200. Sealing device 310 edge surface 331 contacts ridge 267 of dual endcap 200. As a result, sealing device 310 fluidly connects filtration cartridge 160 with dual endcap 200 and creates a watertight seal between surfaces of connector endcap 100 and dual endcap 200.

During use, fluid flows through lumen 12 of sealing device 310 to the lumen of sealing device 410. Sealing device 410 is inserted into first upper orifice 203 of dual endcap 200. Two O-rings of sealing device 410 placed below the central ridge contact orifice interior surface 211 to form a seal between surface of the sealing device 410 and dual endcap 200. Sealing device 410 edge surface 433 contacts a surface of ridge 257 of dual endcap 200, thereby stabilizing

Further, two O-rings above the central ridge of sealing device 410 contact the surface of a channel in cartridge endcap 300, thereby forming a seal between the surfaces of cartridge outlet channel 87 and the sealing device 410. In this example, water flows from the lumen of sealing device 410 through cartridge outlet channel 87 to outlet 83.

Sealing device 510 is also shown in FIG. 9, where sealing device 510 is inserted into second upper orifice 205 at the point where water enters a filtration unit through inlet 81. O-rings 15 contact orifice inner surface 217 and sealing device edge surface 533 contacts a surface of ridge 277. Two O-rings of sealing device 410 contact the surface of a channel in cartridge endcap 300, thereby forming a seal between cartridge endcap inlet channel 511 and the sealing device 510.

This disclosure provides illustrative examples and is intended to provide an overview or framework for understanding the claims. The accompanying drawings are included to provide illustration and a further understanding of the various aspects and examples and are incorporated in and constitute a part of this disclosure. The drawings, together with the specification, serve to explain the disclosed aspects and examples.

1. A sealing assembly, comprising
at least one endcap;
at least one sealing device;
said at least one sealing device comprising a body;
said body portion comprising;
a wall;
said wall having a first surface and a second surface;
said wall having first edge surface and a second edge surface;
said wall defining a lumen that extends through the height of said body;
at least three ridges extending horizontally from said first surface of said wall;
at least two grooves formed by the placement of said at least three ridges;
one sealing ring fitted into each of said at least two grooves; and
wherein at least one of said sealing rings engage with a surface on said at least endcap.

2. The sealing assembly of claim 1, comprising two endcaps.

3. The sealing assembly of claim 2, comprising two connector endcaps.

4. The sealing assembly of claim 2, comprising a connector endcap and a dual endcap.

5. The sealing assembly of claim 2, wherein said two endcaps are different in structure

6. The sealing assembly of claim 1, further comprising at least one filter center connector.

7. The sealing assembly of claim 6, wherein said at least one sealing device is mounted into said filter center connector using an interference fit.

8. The sealing device of claim 1, wherein said body is cylindrical in shape.

9. The sealing device of claim 1, wherein said body is barrel-shaped.

10. The sealing device of claim 1 wherein said sealing device is formed from food grade materials.

11. The sealing device of claim 1, wherein said sealing device has five ridges, forming four grooves;
wherein one sealing ring is fitted into each of said four grooves.

12. The sealing assembly of claim 6, wherein said sealing assembly is fluidly connected with at least one water filtration unit.

13. The sealing assembly of claim 1, wherein said sealing rings are over-molded onto said body of said sealing device.

14. A sealing device, comprising:
a body portion;
said body portion comprising a wall;
said wall having a first surface and a second surface;
said wall having first edge surface and a second edge surface;
said body enclosing a lumen that extends through the height of said body portion;
at least three ridges extending horizontally from said first surface of said wall;
at least two grooves formed by the placement of said at least three ridges;
wherein said at least two grooves are approximately parallel and extend horizontally around said body.

15. The sealing device of claim 14 wherein said body is cylindrical in shape

16. The sealing device of claim 14, wherein said body is barrel-shaped.

17. The sealing device of claim 14, wherein said body is cylindrical

18. The sealing device of claim 14, wherein said sealing device is formed from food grade materials.

19. The sealing device of claim 14, wherein said sealing device has five ridges, forming four grooves;
wherein one sealing ring is fitted into each of said four grooves.

20. The sealing assembly of claim 14, wherein O-rings are over-molded onto said body of said sealing device.
